(19) United States
(12) Patent Application Publication
(10) Pub. No.: US 2006/0243383 A1
(43) Pub. Date: Nov. 2, 2006

(54) Method and device to produce and embossed and printed product and product thereby obtained

(76) Inventors: Mauro Gelli, Lucca (IT); Guido Finoccki', Livorno (IT); Valter Di Nardo, Lucca (IT)

Correspondence Address: BREINER & BREINER, L.L.C., P.O. BOX 19290, ALEXANDRIA, VA, 22320-0290, US

(21) Appl. No.: 10/566,629

(22) PCT Filed: Jul. 27, 2004
(86) PCT No.: PCT/IT04/00413

§ 371 Date: Mar. 9, 2006

(30) Foreign Application Priority Data
Aug. 1, 2003 (IT) FI2003A000208

(51) Int. Cl. B32B 37/00

(52) U.S. Cl. 156/291; 156/209; 156/548; 428/156

(57) ABSTRACT

The device comprises: a first embossing unit (3) with a first embossing roller (5) equipped with a first series of protuberances (5P); a second embossing unit (13) with a second embossing roller (15) equipped with a second series of protuberances (15P) of greater height and lesser density with respect to the protuberances of said first series, said protuberances defining decorative motifs; a glue dispenser (19) associated with said second embossing roller, to apply a glue to a first ply (V1) embossed by said first and said second embossing unit at the protuberances of said second embossing roller; a laminating member (21) associated with said second embossing roller to apply a second ply (V2) to the first ply. At least a printing unit (9), which applies an ink to said first ply (V1) at the protuberances of the first embossing roller, is associated with the first embossing roller (5).

### TECHNICAL FIELD

The present invention relates to a method and a device to produce an embossed web material, composed of two or more layers. The invention also relates to a sheet product composed of two or more coupled layers.

### STATE OF THE ART

In the production of toilet paper, kitchen towels, paper napkins and products made of tissue paper in general, two or more plies or layers of paper are usually combined, at least one of which is subjected to embossing. Embossing is a procedure that, by means of permanent mechanical deformation and partial breakage of the fibers forming the ply, modifies the mechanical and absorbency properties of the ply.

Embossing is performed by feeding the ply or plies to be embossed between an embossing roller, essentially rigid and equipped with protuberances, and a pressure roller, coated in a yielding material, said rollers being pressed against each other.

Embossing is utilized to impart particular technical properties (increased thickness, softness, increased capacity to absorb liquids), and particular aesthetic properties on the finished product. In fact, embossing may be performed by means of rollers with decorative protrusions or protuberances, which form even complex raised patterns on the product.

Decoration of tissue paper products is not limited to embossing. In some cases the product is also printed. Printing normally takes place before embossing and is performed on the face of the ply which—in the finished product—will be facing outwards. This causes some problems, such as the risk of ink release. The use of colored glues with the dual function of making the embossed plies adhere to one another and decorating them partly solves this problem, but causes severe limitations in the type of decoration that can be obtained, due to the strictly technical function of joining the plies that the glue must perform.

EP-B-567604 describes a procedure that has the object of solving these problems. According to this prior art procedure, in the production of an embossed tissue paper product comprising at least two plies, a first ply is embossed and printed, directly on the embossing roller, applying an ink to the protuberances of the first ply produced by the points or protuberances of the embossing roller that performed embossing thereof. For this purpose an inking unit is combined with a first embossing roller and applies the ink before the ply is detached from the embossing roller. A second embossing roller is, on the other hand, combined with a gluing unit. The second embossing roller embosses a second ply, on the protuberances whereof the glue is applied. The two plies thereby embossed and prepared (one inked and the other glued) are laminated together to be bonded and produce the finished product. This procedure solves the problem of the presence of ink on the outside of the finished product, as the ink remains on the inner surface thereof. Moreover, it also solves the problem of restrictions imposed by printing systems that use the colored glue as ink, as in this case the glue is applied to a different ply from the one whereon the ink is applied and at different embossing protuberances to those that are inked. It is thereby possible to obtain printed patterns of different forms with respect to the forms of the protuberances required for gluing.

However, also with this procedure only modest aesthetic effects can be obtained.

WO-A-9944814 describes a method and a device to produce an embossed multi-ply product, through the phases of:
embossing a first ply to produce thereon a first series of protuberances forming a background pattern;
embossing said first ply again to produce thereon a second series of protuberances of greater height and lesser density with respect to the protuberances of the first series and defining decorative motifs, the protuberances of the first series and of the second series projecting from the same side of the ply;
applying a glue to the protuberances of the second series;
making a second ply adhere to the first ply by means of said glue.

In this way it is possible to produce a product wherein the technical properties are imparted by the background embossing and the aesthetic properties are imparted by the embossing formed by the protuberances of the second series, with a series of technical and aesthetic advantages.

Other embossing methods and devices are described in WO-A-0078533.

WO-A-9632248 describes a tip-to-tip embossing system wherein the embossed protuberances are glued together by a colored glue applied by a cliche roller, that is, with zones, to produce geometrical patterns.

### OBJECTS AND SUMMARY OF THE INVENTION

The object of the present invention is to produce a method and a device to obtain embossed and printed multi-ply products with particularly prestigious aesthetic effects.

According to a particular aspect of an advantageous embodiment of the present invention, a further object is to improve the technique described in WO-A-9944814.

Essentially, according to a first aspect, the invention relates to a method to produce an embossed web material, comprising at least two plies coupled by gluing, comprising the steps of: producing on a first ply protuberances defining embossed decorative motifs; applying a glue to at least some of the protuberances defining the decorative motifs; making a second ply adhere to the first ply by means of said glue; characterized in that a colored pattern is applied to the first ply prior to embossing, which may be a background pattern, that is, distributed in an essentially continuous way, or a pattern composed of discrete elements, that is, separate from one another and repetitive. In this case the printed motif and the decorative motif may be phased with each other to obtain on the finished product a combined decoration obtained with two distinct decoration techniques.

According to a preferred embodiment, the invention relates to a method comprising the steps of: embossing a first ply to produce thereon a first series of protuberances forming a background pattern; embossing said first ply again to produce thereon a second series of protuberances of a greater height, lesser density and greater dimensions with respect to the protuberances of the first series and defining decorative motifs, the protuberances of the first series and of the second series projecting from the same side of the ply; applying to the protuberances of the second series a glue; making a second ply adhere to said first ply by means of said glue; wherein an ink is applied to the protuberances of said first series.

By producing the protuberances of the first series with high density and hence reduced dimensions an effect similar to a colored textile texture is produced on the finished product, with color distribution similar to the aesthetic result that can be obtained by coloring the paper during the manufacturing phase, that is, by adding colored ink to the stock. Nonetheless, as the embossed area is essentially lower than 25% of the total surface of the ply and typically between 1% and 20% of the total surface, the quantity of ink employed is much lower than the quantity that would be required to color the entire stock, with the further advantage that the ink is applied only to the inner side of the finished product and is thereby less liable to be released during use of the finished product.

Preferably, the area of the protuberances that is colored ranges from 7 to 10% of the total surface of the ply.

Notwithstanding the greatly reduced percentage of the embossed and printed surface, particularly if the colored points are distributed uniformly, the aesthetic effect obtained may be compared to that of paper colored over its entire surface.

In practice, the protuberances of the first series of protuberances form micro-embossing on the first ply, i.e. an embossing wherein the protuberances have an average density ranging from 20 to 100 protuberances/cm² and preferably from 30 to 90 protuberances/cm² and even more preferably from 30 to 60 protuberances/cm². The protuberances preferably have a simple geometrical form, to produce a sort of background stippling on the ply; protuberances in the form of truncated pyramids are typically used. These may be distributed uniformly on the surface of the ply, although this is not strictly necessary. To add a further aesthetic effect, enhanced by the presence of the dye, it is possible to use arrangements of protuberances characterized by lines without protuberances or lines of protuberances with slightly different dimensions, inserted in a texture of protuberances with the same dimensions.

On the other hand, the protuberances of the second series are typically protuberances with an elongated and curved form. Groups of protuberances form ornamental or decorative motifs.

To obtain an even better aesthetic effect, it is advantageous for the glue applied to the protuberances of the second series to be colored. In this way, the decorative motifs formed by these protuberances will stand out with a color of their own on the background color defined by the dense stippling formed by the protuberances of the first series. In a possible embodiment of the invention, the ink applied to the first protuberances and the glue applied to the second protuberances have different shades of the same base color, for example light blue and sky or darker blue, respectively, with the protuberances defining the decorative motif of a darker or more intense shade with respect to the protuberances of the first series.

The second ply applied to the first ply after dual embossing and coloring may be a smooth or embossed white ply. In this case, it is advantageous for it to be embossed with micro-embossing, analogously to the first ply, although it is not necessary for the protuberances of the first series of protuberances on the first ply and the protuberances on the second ply to have the same dimensions and arrangement.

According to a different aspect, the invention relates to a device to produce an embossed web material, comprising: an embossing unit with an embossing roller equipped with a series of protuberances defining decorative motifs; a glue dispenser, associated with said embossing roller to apply a glue to a first ply embossed by said embossing unit; a laminating member associated with said embossing roller to apply a second ply to the first ply; characterized in that, disposed upstream of said embossing unit, along the path of the first web material, are means to apply a background pattern to said first ply, prior to embossing, said background pattern being colored.

According to a particularly advantageous embodiment, the invention relates to a device to produce an embossed web material, comprising: a first embossing unit with a first embossing roller equipped with a first series of protuberances; a second embossing unit with a second embossing roller equipped with a second series of protuberances of a greater height and lesser density with respect to the protuberances of said first series, said protuberances defining decorative motifs; a glue dispenser, associated with said second embossing roller to apply a glue to a first ply embossed by said first and said second embossing unit at the protuberances of said second embossing roller; a laminating member associated with said second embossing roller to apply a second ply to the first ply. Characteristically, a printing unit, which applies an ink to said first ply at the protuberances of the first embossing roller, is associated with the first embossing roller.

According to yet another aspect, the invention relates to a sheet material comprising at least a first ply and a second ply glued to each other, wherein said first ply is equipped with at least decorative embossing formed by a series of protuberances; said first and said second ply being glued to each other by means of a glue applied at said protuberances; characterized in that said first ply is equipped with a colored background pattern.

According to a preferred embodiment of the invention, a sheet material is provided, comprising at least a first ply and a second ply glued to each other, wherein said first ply is equipped with background embossing formed by a first series of protuberances and decorative embossing formed by a second series of protuberances of lesser density with respect to the protuberances of the first series; said first and said second ply being glued to each other by means of a glue applied at the protuberances of the second series, the protuberances of the first series being essentially free of glue. Characteristically, the tips of the protuberances of the first series are colored.

Preferably, the glue that makes the first ply adhere to the second at the protuberances of the second series—forming the decorative motif—is also colored.

Advantageously, the colored surface of the first ply may be lower than 25% and preferably ranging from 1% to 20% of the total surface of the first ply and preferably ranging from 7% and 10% of the total surface of the first ply.

The protuberances of the second series define decorative motifs of relatively large dimensions, typically formed by several combined lines, distributed according to a density preferably not exceeding three motifs/cm² and preferably around 1-5 motifs per square decimeter.

Further advantageous characteristics and embodiments of the method, the device and the product according to the invention are indicated in the appended dependent claims.

### BRIEF DESCRIPTION OF THE DRAWINGS

The invention shall be better understood by following the description and accompanying drawing, which shows a non-limiting practical embodiment of the invention. More specifically, in the drawing:

FIG. 1 shows an overall schematic side view of a device according to the invention;

FIG. 2 shows an enlargement of the detail II in FIG. 1;

FIG. 3 shows an enlargement of the detail III in FIG. 2;

FIG. 4 shows a plan and partly sectional view of a web material obtained according to the invention;

FIG. 5 shows a schematic cross-section of a portion of the web material in FIG. 4;

FIG. 6 shows a variant of embodiment of the device according to the invention; and

FIG. 7 shows a schematic enlargement of a cross-section of the product according to the invention in a variant of embodiment.

### DETAILED DESCRIPTION OF AN EMBODIMENT OF THE INVENTION

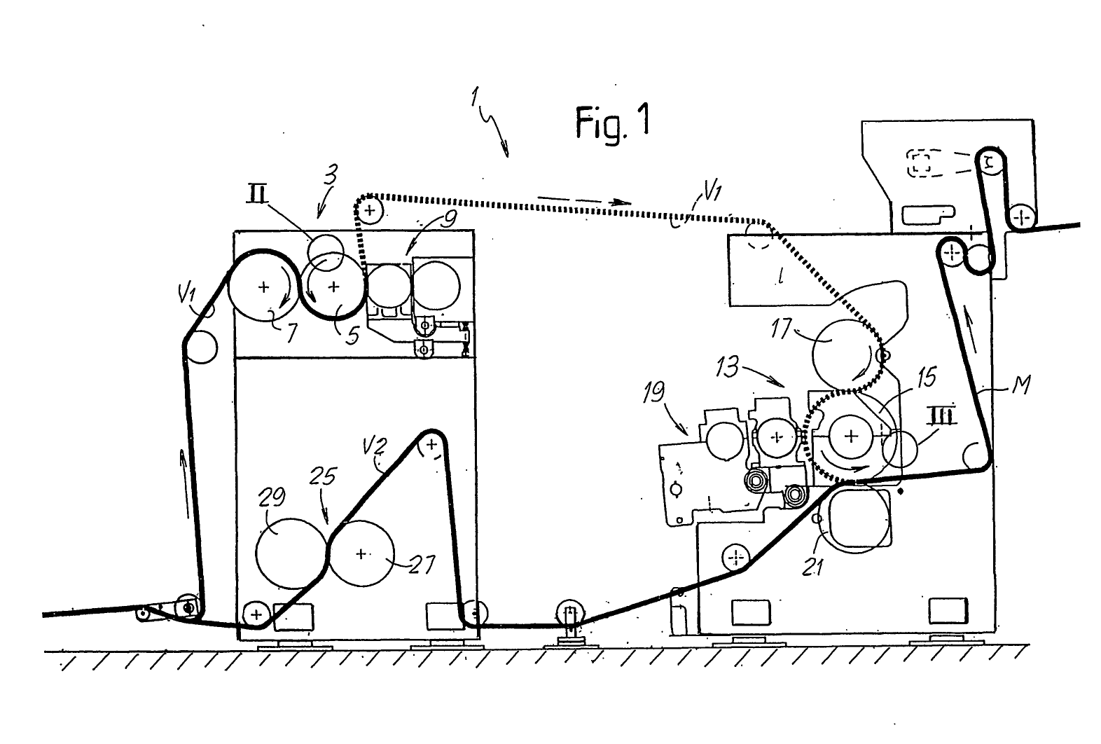

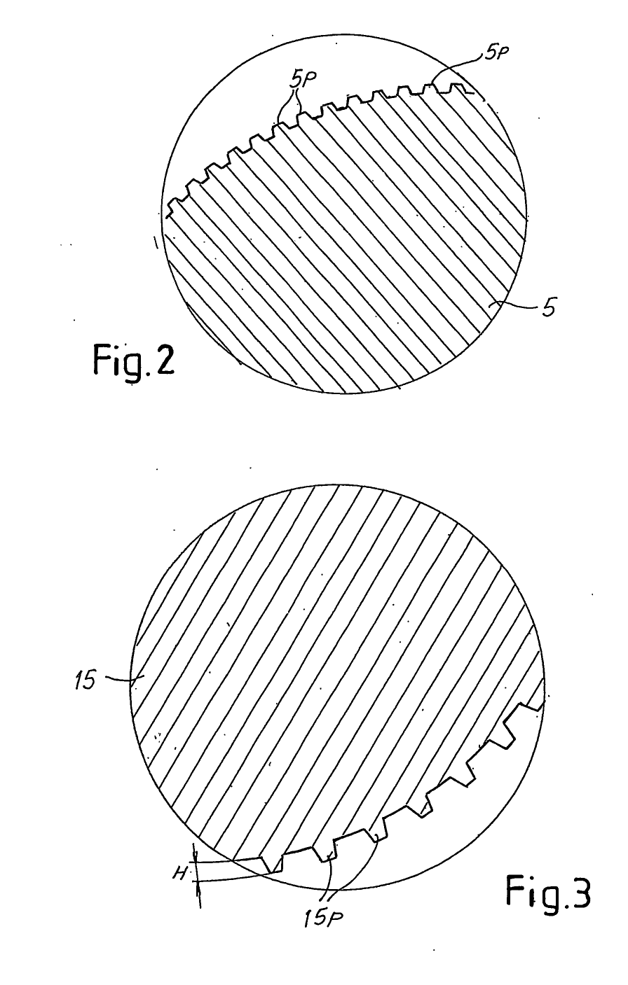

With initial reference to FIG. 1, the device indicated as a whole with 1 comprises a first embossing unit 3 with a first embossing roller 5 and a first pressure roller 7. The pressure roller 7 is coated in rubber or another yielding material, while the first embossing roller is made of steel or another hard material and has a first series of points or protuberances 5P, schematically visible in the enlargement in FIG. 2. These may advantageously be in the form of a truncated pyramid and have a density greater than 20 and preferably greater than 30 protuberances/cm². In general, their density will be such as to give the finished product the effect of micro-embossing.

A printing or inking unit 9 of a per se known type is associated with the first embossing unit 3.

A first ply V1 is fed about the pressure roller 7 and the embossing roller 5 in order to be embossed in the nip between the rollers 7 and 5. The printing unit 9 applies a colored ink to the protuberances thereby produced on this ply. More than one printing unit, which apply inks of different colors to different areas of the ply V1, may be disposed around the embossing roller 5.

The high density and the limited dimension of the protuberances produced on the ply V1 make this coloring create an effect of an almost uniform colored background.

Moreover, the device comprises a second embossing unit, indicated as a whole with 13. It comprises a second embossing roller 15 cooperating with a second pressure roller 17, also coated in yielding material, such as rubber or the like. The embossing roller 15 is equipped (FIG. 3) with a second series of embossing protuberances 15P. The protuberances 15P have a greater height H with respect to the protuberances 5P of the first embossing roller 5 and essentially larger dimensions. These are preferably composed of raised lines, as shall become more apparent with reference to the description of the subsequent FIG. 4.

A glue dispenser 19, of a per se known type, which applies a colored glue C, is associated with the second embossing roller 15. The color of the glue C is preferably analogous to the color of the ink applied by the printing unit 9, but of a different shade and preferably deeper or darker.

The ply V1 coming from the first embossing unit 3 and already embossed thereby, is embossed a second time by the second embossing unit 13 passing through the nip between the rollers 15 and 17. Protuberances of a greater height with respect to the protuberances formed by the first embossing unit are thus formed on the ply V1. The protuberances formed by the two embossing units project from the same face or side of the ply V1. The glue dispenser 19 applies the colored glue to the protuberances formed by the embossing roller 15, without applying it to the protuberances produced by the embossing unit 3, thanks to the lesser height of the latter.

A laminating roller 21 is disposed around the periphery of the roller 15, downstream of the glue dispenser 19 with respect to the direction of feed of the ply V1. A second ply V2 is fed through the nip formed between this laminating roller 21 and the embossing roller 15. The laminating roller 21 has a relatively hard surface and causes coupling by lamination of the two plies V1 and V2, which are made to adhere by the effect of the glue C.

In the example shown the ply V2 has been previously embossed by a third embossing unit 25, which comprises a third embossing roller 27 equipped with protuberances analogous to those of the roller 5, and a third pressure roller 29 coated in a yielding material, similar to roller 7.

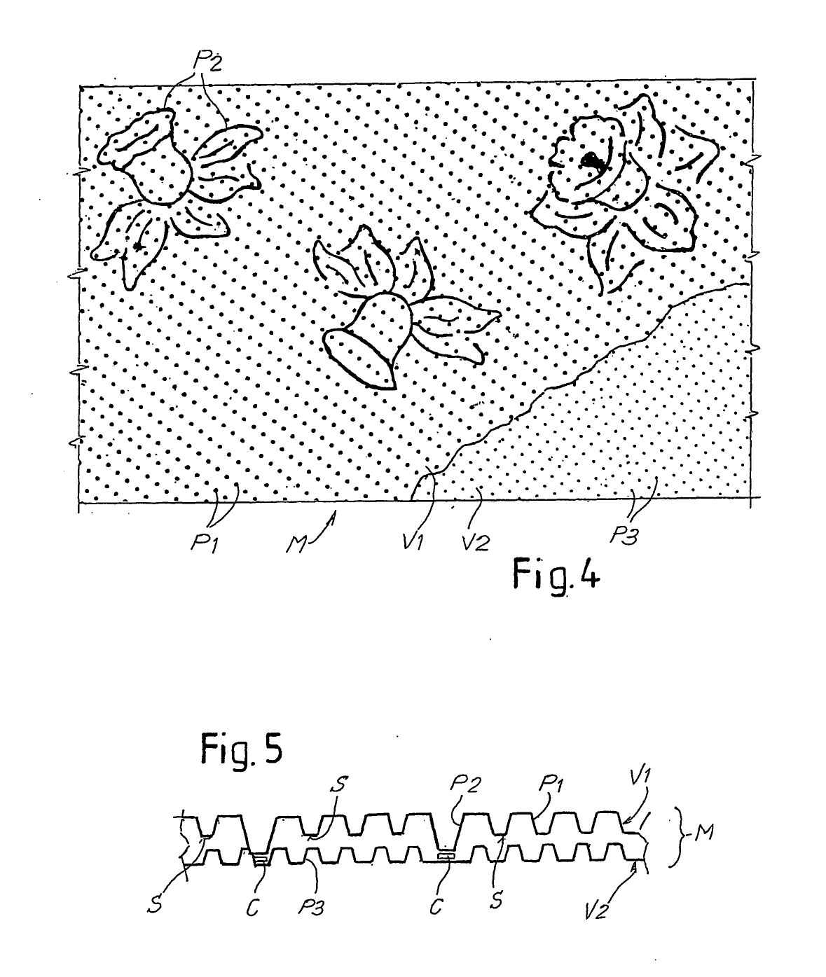

A web material N constituted by the plies V1 and V2, the appearance of which is shown schematically in FIGS. 4 and 5, is obtained downstream of the embossing unit 13. The ply V1 is equipped with a first series of closely arranged small protuberances P1 with a simple geometrical form disposed according to a geometrical arrangement. In the drawing these protuberances are represented by points with an essentially circular form, but it must be understood that they may have different forms, for example square or rectangular, in particular when the protuberances 5P are in the form of truncated pyramids, as frequently occurs, as these are protuberances obtained by the mechanical machining of a smooth roller. The protuberances P1 are colored on their front surface S (FIG. 5) because of the dye applied by the printing unit 9.

Ornamental patterns or motifs, formed by groups of protuberances P2 formed by the embossing roller 15 of the second embossing unit 13, are also present on the ply V1. As can be seen in FIG. 4, the protuberances P2 are generally curvilinear in shape, that is thin and elongated, to form elaborate patterns. The ornamental motifs formed by the lines of the protuberances P2 are distributed according to densities not exceeding 3 motifs/cm² and are therefore in the form of images or patterns that stand out on the background colored by the stippling formed by the protuberances P1.

The second ply V2 is equipped with protuberances P3 of a density and form analogous to those of the protuberances P1, although not necessarily identical. In the example shown, as can be seen in particular in FIG. 5, the protuberances P1 and P3 differ both as regards dimension and density, although it is clearly possible to adopt identical distributions. Alternatively, the ply V2 may be essentially smooth, that is without protuberances added to the base ply after its production. However, the ply V2 may be equipped with a raised motif obtained during the phase to produce the ply, utilizing meshes or wires with a large texture and/or TAD drying systems.

For the reasons set forth above, the front surfaces S of the protuberances P1 and consequently the corresponding front surfaces of the protuberances P3 are free of glue. The protuberances P2 forming the patterns or ornamental motifs are distributed randomly with respect to the protuberances P1 and P3.

As a whole, the web material M has a very elaborate and agreeable aesthetic effect, thanks to the combination of the density of the points or protuberances and to their color, with a front (represented by the outward facing surface of the ply V1) and a back (represented by the outward facing surface of the ply V2). The back may be white or in any case a neutral color, which is the base color of the paper forming both the ply V1 and the ply V2. The front surface of the ply V1 is, on the other hand, densely colored and decorated, although the quantity of dye or ink utilized is minimum with respect to the quantities required in the stock to produce colored paper, with consequent advantages of decreased cost and for the environment.

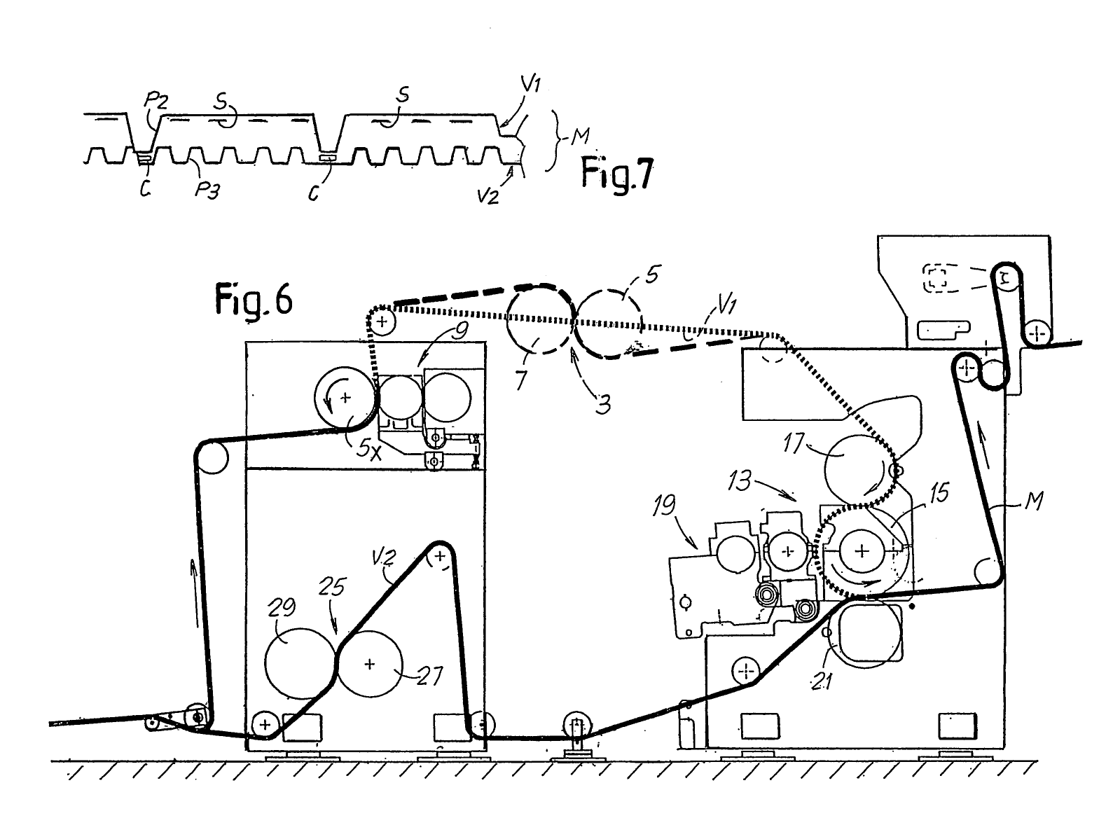

FIG. 6 shows a variant of embodiment of the device according to the invention. The same numbers are used to indicate parts that are the same as or equivalent to those in FIG. 1. The difference between the two arrangements lies essentially in the fact that the first embossing unit 3 is omitted and the embossing roller 5 is replaced by a counter-roller 5X cooperating with the printing unit 9. In this way the first ply V1 is provided with a colored background pattern, which does not coincide with background micro-embossing. This background pattern may be constituted by stippling, by a series of lines or by other more or less dense and more or less geometrical motifs, analogous to those of the micro-embossing arrangements produced in the embodiment in FIG. 1 by the embossing unit 3. The density of the motifs of this background pattern advantageously exceeds that of the motifs embossed by the embossing unit 13. FIG. 7 schematically shows a section of the product obtained, where S once again indicates the areas printed by the printing unit 9.

It would also be possible to produce micro-embossing on the ply V1 downstream of printing, by providing along the path of the ply V1 an embossing unit analogous, for example, to the unit 3, between the printing unit 9 and the embossing unit 13, as represented by the dashed line in FIG. 6.

In a variant of embodiment, instead of being constituted by an essentially uniform background pattern such as stippling or the like, the colored pattern, produced by printing upstream or downstream of the background embossing or on the background embossing, when present, may be constituted by a distribution of printed decorative motifs, analogous to the decorative motifs obtained by embossing, such as the motifs formed by embossing protuberances P2. In the case wherein the colored pattern is produced by coloring the protrusions of background micro-embossing, as described with reference, for example, to FIG. 4, the background embossing protuberances may be colored only in areas, for example with a cliche inking cylinder. In this case the small points or protuberances of the background embossing that are colored form decorative elements separated by areas wherein these protuberances are not colored. Advantageously, according to an advantageous embodiment of the invention, the colored patterns are place in phase with the decorative elements obtained by embossing, that is, those defined by the protuberances P2, for example. In this way a finished product is obtained that is decorated by means of a composite technique of embossing and printing, where the printing may be stippled or continuous.

When the printing ink is applied to the protuberances of a background micro-embossing, the effect obtained may be of stippled decoration or also of essentially continuous coloring. This depends for example on the absorption capacity of the base material, typically tissue paper, on the dimension and density of the micro-embossing protuberances, on the quantity of ink applied. This allows the operator a further margin of freedom in the choice of the material to be produced by means of specific selection of these parameters.

It is understood that the drawing merely shows a practical embodiment of the invention, which may vary in forms and layouts without however departing from the scope of the concept on which the invention is based. Any reference numerals in the appended claims are provided purely to facilitate reading in the light of the description hereinbefore and of the accompanying drawings, and do not limit the scope of protection whatsoever.

1-43. (canceled)

44. A method to produce an embossed web material, comprising at least two plies coupled to each other by gluing, including the following steps: producing on a first ply protuberances defining embossed decorative motifs; applying a glue to at least some of the protuberances defining the decorative motifs; making a second ply adhere to the first ply by means of said glue; wherein a colored pattern is applied to said first ply prior to producing said embossed decorative motifs by means of embossing.

45. Method as claimed in claim 44, wherein said first ply is embossed between a pressure roller and an embossing roller provided with protuberances defining said decorative motifs, and wherein said glue is applied to said first ply while the first ply is still in contact with said embossing roller.

46. Method as claimed in claim 44, including embossing the first ply a first time to produce thereon a first series of protuberances forming an embossed background pattern and subsequently embossing said first ply again to produce thereon a second series of protuberances of a greater height and lesser density with respect to the protuberances of the first series and defining said decorative motifs.

47. Method as claimed in claim 45, including embossing the first ply a first time to produce thereon a first series of protuberances forming an embossed background pattern and subsequently embossing said first ply again to produce thereon a second series of protuberances of a greater height and lesser density with respect to the protuberances of the first series and defining said decorative motifs.

48. Method as claimed in claim 44, including the following steps:
embossing the first ply to produce thereon a first series of protuberances forming an embossed background pattern;
applying an ink to at least some of the protuberances of said first series to form said colored pattern;
embossing said first ply again to produce thereon a second series of protuberances of a greater height and lesser density with respect to the protuberances of the first series and defining said decorative motifs, the protuberances of the first series and of the second series projecting from the same side of the ply;
applying to the protuberances of the second series a glue;
making a second ply adhere to the first ply by means of said glue.

49. Method as claimed in claim 45, including the following steps:
embossing the first ply to produce thereon a first series of protuberances forming an embossed background pattern;
applying an ink to at least some of the protuberances of said first series to form said colored pattern;
embossing said first ply again to produce thereon a second series of protuberances of a greater height and lesser density with respect to the protuberances of the first series and defining said decorative motifs, the protuberances of the first series and of the second series projecting from the same side of the ply;
applying to the protuberances of the second series a glue;
making a second ply adhere to the first ply by means of said glue.

50. Method as claimed in claim 46, including the following steps:
embossing the first ply to produce thereon a first series of protuberances forming an embossed background pattern;
applying an ink to at least some of the protuberances of said first series to form said colored pattern;
embossing said first ply again to produce thereon a second series of protuberances of a greater height and lesser density with respect to the protuberances of the first series and defining said decorative motifs, the protuberances of the first series and of the second series projecting from the same side of the ply;
applying to the protuberances of the second series a glue;
making a second ply adhere to the first ply by means of said glue.

51. Method as claimed in claim 46, wherein the protuberances of the first series have an average density ranging from 20 to 100 protuberances/cm².

52. Method as claimed in claim 46, wherein the protuberances of the first series occupy a percentage lower than 25% of the total surface of the first ply.

53. Method as claimed in claim 44, wherein said glue is colored.

54. Method as claimed in claim 53, wherein said glue and said ink have different shades of a same color.

55. Method as claimed in claim 44, wherein said second ply is embossed with background embossing prior to coupling with the first ply.

56. Method as claimed in claim 55, wherein said second ply is embossed with a third series of protuberances with an average density ranging from 20 to 100 protuberances/cm².

57. Method as claimed in claim 55, wherein the protuberances of said third series occupy a percentage below 25% of the total surface of the second ply.

58. Method as claimed in claim 44, wherein the decorative motifs formed by the protuberances of the second series are distributed according to a density not exceeding 3 motifs/cm².

59. Method as claimed in claim 44, wherein said colored pattern is produced by printing the first smooth ply.

60. Method as claimed in claim 59, wherein first ply is micro-embossed after said colored pattern is applied.

61. Method as claimed in claim 44, wherein said printed pattern is a background pattern distributed essentially uniformly over the entire surface of the ply.

62. Method as claimed in claim 44, wherein said first ply is provided with a colored background pattern constituted by stippling or by a series of lines.

63. Method as claimed in at least claim 48, wherein said protuberances of the first series are colored to form a colored background pattern.

64. Method as claimed in claim 44, wherein said colored pattern is phased with said decorative patterns to form a composite printed and embossed pattern.

65. A device to produce an embossed web material, including: an embossing unit with an embossing roller equipped with a series of protuberances defining decorative motifs; a glue dispenser, arranged adjacent said embossing roller and co-acting therewith to apply glue to a first ply embossed by said embossing unit when said first ply is still in contact with said embossing roller; a laminating member disposed around a periphery of the embossing roller, downstream of the glue dispenser with respect to a direction of feed of said first ply to apply by lamination a second ply to the first ply; wherein, disposed upstream of said embossing unit, along a path of the first web material, are means to apply a colored pattern to said first ply, prior to embossing by means of said embossing roller.

66. Device as claimed in claim 65, wherein said means to apply a colored pattern on the first ply comprise at least a printing unit.

67. Device as claimed in claim 65, including in combination: a first embossing unit with a first embossing roller equipped with a first series of protuberances; downstream of said first embossing unit, a second embossing unit with a second embossing roller equipped with a second series of protuberances of greater height and lesser density with respect to the protuberances of said first series, said protuberances defining decorative motifs, said glue dispenser being arranged around said second embossing roller, to apply a glue at the protuberances of said second embossing roller; said laminating member being associated with said second embossing roller.

68. Device as claimed in claim 66, including in combination: a first embossing unit with a first embossing roller equipped with a first series of protuberances; downstream of said first embossing unit, a second embossing unit with a second embossing roller equipped with a second series of protuberances of greater height and lesser density with respect to the protuberances of said first series, said protuberances defining decorative motifs, said glue dispenser being arranged around said second embossing roller, to apply a glue at the protuberances of said second embossing roller; said laminating member being associated with said second embossing roller.

69. Device as claimed in claims 68, wherein said at least one printing unit is arranged around said first embossing roller and applies an ink to said first ply to at least some of the protuberances of the first embossing roller.

70. Device as claimed in claim 67, wherein the protuberances of the first embossing roller have an average density ranging from 20 to 100 protuberances/cm².

71. Device as claimed in claim 65, wherein said glue dispenser contains a colored glue.

72. Device as claimed in claim 65, wherein the decorative patterns defined by the protuberances of the second series have a density not exceeding 3 motifs/cm².

73. Device as claimed in claim 66, including in combination: a first embossing unit with a first embossing roller equipped with a first series of protuberances; downstream of said first embossing unit, a second embossing unit with a second embossing roller equipped with a second series of protuberances of greater height and lesser density with respect to the protuberances of said first series, said protuberances defining decorative motifs, said glue dispenser being associated with said second embossing roller, to apply a glue at the protuberances of said second embossing roller; said laminating member being associated with said second embossing roller; and wherein said at least a printing unit, which applies an ink to said first ply, is disposed upstream of said second embossing unit and, optionally, upstream of said first embossing roller.

74. Device as claimed in claim 66, wherein said printing unit and said embossing roller equipped with protuberances defining said decorative patterns are phased with each other to produce composite printed and embossed patterns.

75. A sheet material comprising at least a first ply and a second ply glued together, wherein said first ply is equipped with at least a decorative embossing formed by a series of protuberances; said first ply and said second ply being glued together by means of a glue applied to at least some of said protuberances; and wherein said first ply is equipped with a colored pattern.

76. Material as claimed in claim 75, wherein said first ply is equipped with background embossing formed by a first series of protuberances and decorative embossing formed by a second series of protuberances of lesser density with respect to the protuberances of the first series; said first ply and said second ply being glued together by a glue applied to at least some of said protuberances of the second series, the protuberances of the first series being essentially free of glue.

77. Material as claimed in claim 76, wherein at least some of the protuberances of the first series are colored.

78. Material as claimed in claim 75, wherein said glue is colored.

79. Material as claimed in claims 78, wherein said glue is colored and wherein said protuberances of the first series are colored with a different shade of the same color with which the glue is colored.

80. Material as claimed in claim 76, wherein the protuberances of the first series have an average density ranging from 20 to 100 protuberances/cm².

81. Material as claimed in claim 75 wherein the colored surface of said first ply is lower than 25% of the total surface of the first ply.

82. Material as claimed in claim 76, wherein the protuberances of the second series define decorative motifs distributed according to a density not exceeding three motifs/cm².

83. Material as claimed in claim 75, wherein said second ply has a background embossing defined by a third series of protuberances.

84. Material as claimed in claim 83, wherein the protuberances of said third series are distributed with a density ranging from 20 to 100 protuberances/cm².

85. Material as claimed in claim 75, wherein said second ply is free of protuberances added to the second ply after its production.

86. Material as claimed in claim 75, wherein the base color of said first ply and second ply is neutral.

87. Material as claimed in claim 76, wherein said colored pattern is a background pattern constituted by coloring the protuberances of said first series of protuberances forming the background embossing.

88. Material as claimed in claim 75, wherein said colored pattern and said decorative embossing are phased with each other to form composite printed and embossed decorations.

89. Material as claimed in claim 88, wherein said printed colored pattern is a background pattern distributed essentially uniformly over the entire surface of the ply.

90. Material according to claim 89, wherein said printed background pattern is constituted by a stippling or by a series of lines.
